(19) United States
(12) Patent Application Publication
(10) Pub. No.: US 2010/0293968 A1
(43) Pub. Date: Nov. 25, 2010

(54) PIEZO-HYDRAULIC COMPRESSOR/PRESSURE OSCILLATOR FOR CRYOGENIC COOLING AND OTHER APPLICATIONS

(75) Inventors: Isaac Garaway, Haifa (IL); Gershon Grossman, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: TECHNION RESEARCH AND DEVELOPMENT FOUNDATION LTD., Haifa (IL)

(21) Appl. No.: 12/668,985

(22) PCT Filed: Jul. 15, 2008
(86) PCT No.: PCT/IL2008/000982

§ 371 Date: Jul. 8, 2010

Related U.S. Application Data
(60) Provisional application No. 60/950,079, filed on Jul. 16, 2007.

(51) Int. Cl. F25B 9/02; F02G 1/043; F04B 43/04

(52) U.S. Cl. 62/51.2; 60/517; 417/413.2

(57) ABSTRACT

In recent years piezoelectric actuation has been identified as a promising means of driving miniature Stirling devices. It supports miniaturization, has a high power to volume ratio, can operate at almost any frequency, good electrical to mechanical efficiencies, and potentially has a very long operating life. This invention uses a valve-less hydraulic amplification, creating an oscillating pressure wave sufficiently large to drive a high frequency miniature pulse tube cryocooler. The actuator may be separated from the main body of the cryocooler. The system lack of rubbing parts in the power conversion processes.

### FIELD OF THE INVENTION

The invention is concerned with a miniature device designed to provide pressure oscillations and/or compression to a gas serving as a working fluid, as required in cooling/refrigeration systems and perhaps in other applications.

### BACKGROUND OF THE INVENTION

Actuators using the piezoelectric effect, of converting electrical energy to mechanical energy and vice-versa, have been commercially available for over 35 years. In that time they have transformed the world of precision positioning and motion control. The precise but also rapid motion that results when an electric potential is applied to piezoelectric materials has proved quite useful for many technologies. Piezoelectric actuators derive their motion from solid-state crystalline effects, so in the classical sense of the term they do not undergo wear like most actuation devices. This leads to highly reliable and robust devices requiring no maintenance and yet capable of rapidly positioning heavy loads up to several tons. Another benefit of this solid state crystalline effect is the high power to volume ratios which are attainable. The relatively high natural frequencies of the ceramic materials, on the order of 10's to 100's of KHz and beyond, lead to very fast response times on order of milliseconds. Also, these piezoelectric ceramics are capacitive loads, thus dissipate virtually no power in static operation. In dynamic operation there is some heat generated in the material which does lead to thermal power loss. However, even in the less than ideal conditions of dynamic operation the electrical to work efficiency of these devices still approaches 90%.

This combination of high reliability and efficiency has led many to believe that piezoelectric devices are not only fit for precision motion control but can also provide the primary power drive in miniature thermo-mechanical systems. Recently it has been identified as a promising means of driving miniature Stirling devices. The intrinsic characteristics of piezoelectric materials, mainly their high power to volume ratio and their ability to operate at a wide range of frequencies, have singled them out as prime candidates for miniaturization schemes. There have been practical proposals to make use of piezoelectric materials in miniature Stirling cycle cryocoolers. In a patent application [1] describing a completely MEMS manufactured cryocooler, there is mention of using two opposing oscillating diaphragms, each attached to a piezoelectric actuator. Necessary controls are implemented to operate these actuators at frequencies approaching 500 Hz while retaining the necessary phase shifting between the two diaphragms.

The major drawback of piezoelectric actuation, however, is that piezoelectric ceramics can produce very large stresses but are quite limited in their strain output. This leads to very small relative displacements, on order of about 0.1% of the length scale of the piezoelectric stack. This fact alone is a major drawback and has hampered the development of piezoelectric actuators as the primary drivers for miniature Stirling devices. Lacking an effective means of amplifying this displacement into a range useable for gas compression, a working miniature Stirling cryocooler, driven by a piezoelectric element, is not viable. In order to overcome this obstacle, this project employed the use of a hydraulic amplification scheme.

U.S. Pat. No. 5,779,149 to Hayes, Jr. titled “Piezoelectric controlled common rail injector with hydraulic amplification of piezoelectric stroke”, discloses a common rail fuel injector utilizes a piezoelectric actuator to open and close the injector valve. Intermediate the piezoelectric actuator and the injector valve are a large diameter first piston in fluid communication with a smaller diameter second piston to multiply the actuation extension of the piezoelectric actuator. The second piston operates a poppet valve to hydraulically control the injector valve.

U.S. Pat. No. 5,941,079; to Bowman, et al. titled “Microminiature stirling cycle cryocoolers and engines”, discloses a microminiature Stirling cycle engine or cooler is formed utilizing semiconductor, planar processing techniques. Such a Stirling cycle thermomechanical transducer has silicon end plates and an intermediate regenerator. The end plates are formed with diaphragms and backspaces, one end plate forming the expansion end and the opposite end plate forming the compression end, with the regenerator bonded in between. A control circuit apparatus is linked to the diaphragms for controlling the amplitude, phase and frequency of their deflections. The control circuit apparatus is adapted to operate the transducer above 500 Hz and the passages and the workspace, including those within the regenerator, expansion space and compression space, are sufficiently narrow to provide a characteristic Wolmersley number, which is characteristic of the irreversibilities generated by the oscillating flow of the working fluid in the workspace, below substantially 5 at the operating frequency above 500 Hz. Additionally, the amplitude of the vibrations of the diaphragm vibrations are sufficiently small to provide the working fluid a maximum Mach number below substantially 0.1 at an operating frequency above 500 Hz.

### REFERENCES

1. Sirohi J., Cadou C., Chopra I., Investigation of a piezohydraulic actuator. Journal of Intelligent Material Systems and Structures 16 (2005) pp. 481-492
2. Tan H., Hurst W., Leo D., Performance modeling of a piezohydraulic actuation system with active valves. Smart Materials and Structures 14 (2005) pp. 91-110
3. Garaway I., Grossman G., A study of a high frequency reservoir-less pulse tube (publication pending CEC-ICMC 2007)
4. Garaway I., Grossman G.; Studies in high frequency oscillating compressible flow for micro-regenerative cryocoolers, Adv. Cryogenic Engineering 51B (2006) pp. 1588-1595

### SUMMARY OF THE INVENTION

The invention is concerned with a device designed to provide pressure oscillations and/or compression to a gas serving as a working fluid, as required in cooling/refrigeration systems and perhaps in other applications. Our specific invention was developed under a project for cryogenic cooling which requires high-frequency pressure oscillations in the working fluid (preferably Helium is used as working gas, but other working gases such as Hydrogen, Nitrogen, and Argon may be used).

Conventional compressors currently used for these purposes are driven by electromagnetic motors which are limited in their efficiency, frequency range and the ability to miniaturize them. The intrinsic characteristics of piezoelectric materials, mainly their high power to volume ratio and their ability to operate at a wide range of frequencies, have singled them out as prime candidates for compressor miniaturization schemes. The major drawback of piezoelectric actuators, however, is that piezoelectric ceramics can produce very large stresses but are quite limited in their strain output. This leads to very small relative displacements, on order of about 0.1% of the length scale of the piezoelectric actuator. This fact alone is a major drawback and has thus far hampered the development of piezoelectric based compressors as primary drivers for miniature thermo-mechanical devices. Lacking an effective means of amplifying and transferring this small strain into a displacement useable for gas compression—a working miniature compressor, driven by a piezoelectric element, is not viable.

The solution to this problem is what we refer to as a Piezohydraulic Membrane actuator. A piezohydraulic actuator is a hybrid device consisting of a piezoelectric actuator coupled to a hydraulic amplification/transmission system which in turn drives a gas compressing membrane. In recent years there has been general interest in coupling hydraulic fluid to piezoelectric actuators as a means of taking advantage of the benefits inherent to piezoelectric ceramics and the versatility of fluid power transmission. These ideas, however, have not yet developed into solutions for miniature oscillating gas compressors. Our inventive device is based on coupling a piezoelectric actuator (which delivers large forces at small displacements) to a hydraulic amplifier (which increases and transfers the amplitude of displacement) and replacing the conventional compressor piston by special impervious but flexible membranes, thereby performing compression with the following advantages:
A small high-pressure head separated from the actuator by a tube of significant length without detrimental dead volume and phase shifting
Use of oscillating membranes vs. pistons solves issues of wear/sealing/dead compression space
Membrane flip-flops with minimum stretching to assure long term operation with minimum fatigue and wear
High efficiency and reliability of piezoelectric actuator relative to electromagnetic drivers at wide frequency range

The schematic drawing describes the principal components of the device, showing the piezoelectric actuator imparting small amplitude oscillatory motion to a large area membrane mounted in such a way as to provide a large fluid volume displacement. This chamber is physically separated from a small compression chamber by a transfer line. The small area membrane is placed in a housing in such a way as to allow for the complete compression of the gas above it with almost “zero dead-space compression volume”. The two chambers are connected to each other by a transfer line, and the assembly is filled with hydraulic fluid. This makes it possible to separate the actuator with its associated vibrations from the compression chamber, which may be miniaturized and coupled to the cooling device at minimum vibrations and dead volume.

A complete experimental test system was built in our laboratory. In the experimental demonstration setup, the piezoelectric actuator is encased in a relatively large steel casing for experimental purposes and can be further miniaturized without difficulty. A transparent transfer line was employed, and all the flanges have been machined from clear Plexiglas to enable external viewing and filming of the process. The gas compression membrane flange was connected to the miniature cryocooler inside of the vacuum Dewar.

It should be clear to the man of the art that transparency of the tube and flanges was chosen for experimental convenience and in the preferred embodiments choice of component materials will depend on the application, cost of manufacturing, strength of material (hence the ability to reduce the size), etc.

The device according to the general scope of the invention may play an important role in cryogenic cooling systems where it can replace conventional electromagnetically-driven compressors, thereby allowing miniaturization and vibration free operation. This will open a whole range of applications for these miniature cryogenic devices, in night vision, different detection devices, superconducting devices, medical cryosurgery and more. It is anticipated that this novel compression device will find applications wherever miniature compressors, pressure oscillators and vacuum pumps may be needed.

It is an object of the current invention to provide a pressure oscillator comprising: a transducer cyclically pushing a main piston; hydraulic fluid transferring pressure oscillations caused by main piston to a membrane, wherein size of said membrane is smaller than size of said main; and a compression chamber having said membrane as part of its wall filled with compressible gas, wherein said gas affected by cyclic oscillations of said membrane thus cyclically compressed.

In some embodiments the pressure oscillator of claim 1 and further comprises a cryo-cooler operated by said cyclically compressed gas.

In some embodiments the transducer is a PZT transducer.

In some embodiments the oscillator further comprises a transfer tube transferring said hydraulic pressure oscillations from said main piston to said membrane.

In some embodiments the moving part of said flip-flop membrane has substantially hemispherical shape.

In some embodiments the moving part of said flip-flop membrane substantially matches the volume of said compression chamber.

In some embodiments the compression chamber has substantially hemispherical shape.

In some embodiments the compression chamber and moving part of said flip-flop membrane have substantially same hemispherical shape.

In some embodiments the main piston uses a membrane.

In some embodiments the pressure oscillator further comprises: a one way gas input valve allowing low pressure gas to enter said compression chamber; and a one way gas output valve allowing high pressure gas to exit said compression chamber.

In some embodiments the pressure oscillator further comprises a close gas system receiving high pressure gas from output valve and returning said gas at low pressure to input valve.

In some embodiments the close gas system is a Joule Thomson cryo-cooler.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 schematically depicts a complete system having a Piezohydraulic Membrane Oscillator according to an exemplary embodiment of the current invention.

FIG. 2 schematically depicts the construction of the main driver according to an exemplary embodiment of the current invention.

FIG. 3 schematically depicts the Flip-flop membrane according to an exemplary embodiment of the current invention.

FIG. 4 schematically depicts a compression volume incorporating an oscillating membrane and a negative compression space according to an exemplary embodiment of the current invention.

FIG. 5 depicts a graph of the operation at 20 Hz indicating:

(a) Pressure profiles of the hydraulic fluid and the Helium,

(b) PZT actuator displacement;

from an experimental setup constructed according to the current invention.

FIG. 6 depicts a graph of the operation at 20 Hz with insufficient compression volume in the compression space measured in an experimental setup constructed according to the current invention.

FIG. 7 depicts a graph of the phase shift between actuator displacement and pressure at membrane at 130 Hz measured in an experimental setup constructed according to the current invention.

FIG. 8 schematically depicts an IR sensor system using miniature PZT driven cryocooler according to the current invention.

### DESCRIPTION OF THE PREFERRED EMBODIMENTS

The invention is concerned with a device designed to provide pressure oscillations and/or compression to a gas serving as a working fluid, as required in cooling/refrigeration systems and perhaps in other applications.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For clarity, non-essential elements were omitted from some of the drawings.

As used herein, an element or step recited in the singular and proceeded with the word “a” or “an” should be understood as not excluding plural elements or steps, unless such exclusion is explicitly recited.

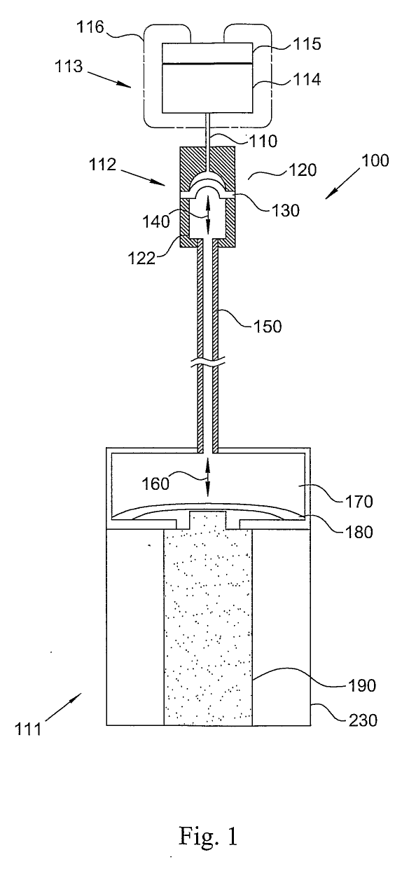

FIG. 1 schematically depicts a description of a system using the Piezohydraulic Membrane Oscillator according to an exemplary embodiment of the current invention.

System 100 comprises the following main components:

Main driver 111 connected by transfer tube 150 to compression volume 112 which is connected by small (and also unnecessary) helium transfer line 110 to the pulse tube inside the cryostat 113.

Main driver 111 generates hydraulic oscillation in hydraulic fluid. The hydraulic fluid transfers the hydraulic oscillation through transfer tube 150 to compression volume 112.

In compression volume 112, the pressure oscillations are amplified and transferred from the preferably incompressible hydraulic fluid to the working gas.

Pressure oscillations in the working gas are preferably transferred through very short helium transfer tube 110 to pulse tube cryocooler within cryostat 113. However, pulse tube cryocooler and cryostat 113 may be replaced by other devices utilizing the pressure oscillations in the working gas.

In the preferred embodiment, the preferably thermally insulated cryostat 113, surrounded by thermal insulation 116, comprises a cyocooler 114, for example miniature Stirling cycle cryocooler and “cold payload” 115, for example an Infra-Red (IR) detector.

A piezohydraulic actuator is a hybrid device consisting of a piezoelectric actuator coupled to some sort of hydraulic amplification/transmission system. In recent years there has been considerable interest in such systems as a means of taking advantage of the aforementioned benefits inherent to piezoelectric actuators and the versatility of fluid power transmission. The large majority of studies conducted so far in this field have primarily focused their efforts on rectifying the high frequency, small stroke oscillating movements of the piezoelectric stack into the movement at a specific combination of stroke and force. Such devices require the use of fast acting active valves to rectify the high frequency piezoelectric strokes into a useable power stroke. Some of these studies, which included the building of a working prototype, investigated the dynamic response of such systems and determined the effect of factors such as tubing length, fluid viscosity, and compressibility and their effects on the dynamic characteristic of the system. Among other things, these works also show that the high frequency active valves add considerable complexities both to the operation of the system and to the optimization scheme, even more so as the operating frequency increased. As a result of these complexities associated with rectification schemes, piezohydraulic actuators have not yet developed into viable solutions for miniature oscillating gas compressors for thermo-mechanical systems.

Various thermo-mechanical systems, such as Stirling devices which only need a simple pressure oscillator, allow for significant simplification of such amplification schemes. The device presented in this work simplifies the amplification method considerably by substituting active valve rectification with the simple concept of hydraulic volume displacement. As the volume of an incompressible fluid is maintained constant at all times, the small amplitude of movement of a large area master piston will be magnified greatly as it is translated through the incompressible fluid to a slave piston having a small area. This device, which we refer to as a Piezohydraulic Membrane Oscillator, includes a necessary small area flexible membrane. In our design, this membrane is capable of turning inside-out during the reversal of motion (flip-flop) thus allowing larger displacements with almost no stretching. This special impervious but flexible flip-flop membrane not only performs the volume displacement of the master piston but takes advantage of this volume displacement completely by performing complete compression within a given compression space, i.e. leaving no dead volume. FIG. 1, is a schematic showing the principal components of the device. The piezoelectric actuator imparts small amplitude oscillatory motion to a large area master membrane mounted in such a way as to provide a large fluid volume displacement. This chamber is optionally physically separated from a small compression chamber by a hydraulic fluid transfer line. The small area flip-flop membrane is placed within a compression space in such a way as to allow for the complete compression of the gas above it almost “zero dead-space compression volume”. The transfer line configuration makes it possible to separate the actuator with its associated vibrations from the compression chamber.

The heart of the compression system is the piezoelectric actuator. For the initial experimentation we chose a relatively large (120 mm long) actuator, the P-245.70 from PI Ceramic GmbH (Germany). It is a high voltage, pre-loaded encased actuator, having a maximum travel of 120 μm with a stiffness of 15 N/μm capable of giving 2000 N/300 N (push/pull) force. The incorporated pre-loading, in theory unnecessary as there is always an “inherent” pre-load force due to the Helium fill pressure of the cryocooler, was recommended for the safety of the actuator due to the broad range of dynamic loads and frequencies reached during experimentation. The actuator also came with an attached strain gauge to provide additional data regarding the actuator's location, necessary for accurate PV power calculations. The high voltage power supply, the PI-E-471, in conjunction with this actuator can provide up to a maximum of 13 Watts of power at 120 Hz. As the frequency further increases, the power rating drops due to the high capacitance of this specific actuator which prevents it from reaching the full 120 μm of displacement at higher frequencies by means of this power supply. This choice of actuator, far from ideal in terms of size and power characteristics, was taken so as to allow for maximum experimental flexibility both in terms of our ability to provide a broad range of pressure amplitudes but also across a large frequency range.

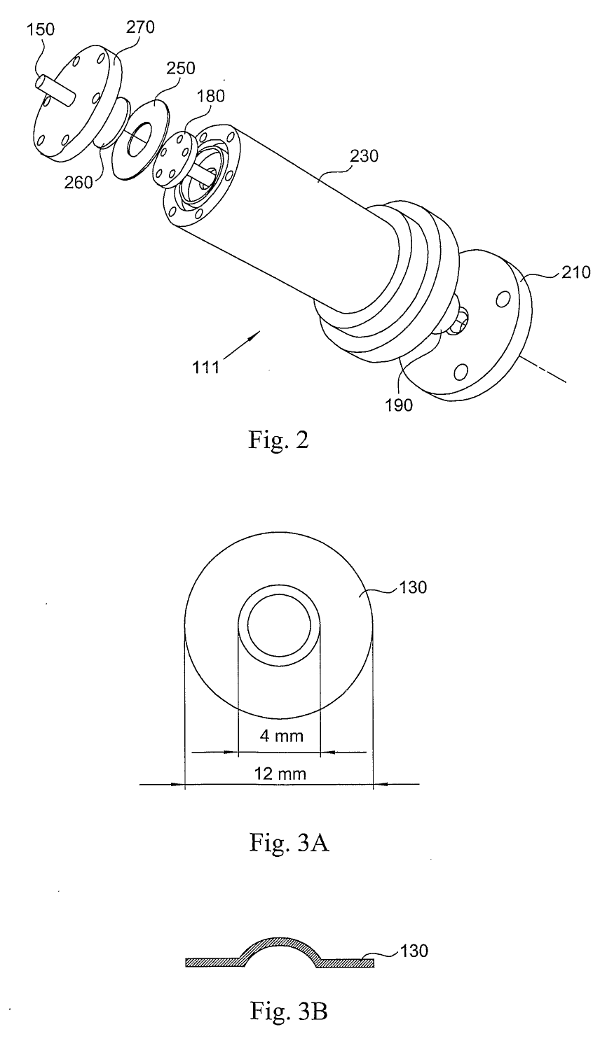

As can be seen from FIG. 2, the actuator was put inside an additional pressure housing; necessary for pressurizing this specific experimental system but may be considerably miniaturized without difficulty.

Transfer Tube

For experimental purposes a 0.5 meter “transparent” thick walled Teflon tube was chosen (i.d.-2 mm/outer diameter-4 mm). The Teflon tubing having relatively stiff walls still had a bit of elasticity, causing some detrimental volume change in the system during the oscillating cycle which will be addressed later. This resulted in compressibility effects and for PV work to be lost to the Teflon tube rather than being transferred to the flip-flop membrane. The Teflon tubing was retained, however, despite this drawback so as to allow viewing/filming capabilities that were important at this stage of experimentation.

It should be noted that preferably the transfer tube may be made as short as possible and made from stiff material, such as metal, to reduce pressure loss. Length and diameter of the tube may be optimized to reduce one or some of: power losses due to liquid compression; power losses due to liquid viscosity; to reduce system size; reduce system weight; and reduce system cost. Tube may be rigid, semi-rigid or comprise of flexible section according to the application.

Additionally or optionally, a lower viscosity but also lower density fluid may be employed; this will prevent excess work loss to fluid friction as well as assist in preventing inertial effects such as phase shifting in the transfer line.

FIG. 2 schematically depicts the main driver according to an exemplary embodiment of the current invention.

Main driver 111 comprises a housing 230 sealed on one end by base 210 and on the other hand by flange 270 from which transfer line 150 is protruding.

PZT actuator 220 is housed in housing 230 and in response to electrical signals from electrical driver (not shown here for simplicity) pushes on main driver piston 180. Main membrane 250 which is preferably flexible but not easily stretchable is hermetically secured to main driver piston 180 by retaining disk 260. The outer rim of main membrane 250 is hermetically secured between housing 230 and flange 270.

Hydraulic fluid displacement 170 is defined between main membrane 250 and retaining disk 270 and flange 270. Although the stroke 160 of master piston 180 is small, the displacement volume of hydraulic fluid is substantial due to the relative large diameter of main piston 180.

Master Piston

To simplify the mechanics, the master piston was made from a relatively small flat plate piston in the first test system. Essentially two 18.0 mm diameter disks, the bottom disk screwed into the piezoelectric actuator and the second sandwiched a rubber seal (main membrane) that sealed the main driver hydraulic volume. These details can be seen in the exploded schematic of the main driver volume shown in FIG. 2. To effectively miniaturize the system this simple “small” piston geometry would need to be modified to allow for a much larger area cross-section to undergo displacement. Enlarging the cross-sectional area of the Master piston will allow increased hydraulic volume displacement for much shorter PZT actuators.

FIG. 3 shows a Flip-flop membrane according to an exemplary embodiment of the current invention. FIG. 3A depicts a top view of the Flip-flop membrane 130 while FIG. 3B depicts a cross section of the Flip-flop membrane 130.

Flip-Flop Membrane

The membrane, the most novel of the device sub-components, took some time to develop. Initial experiments were conducted using flat latex-based membranes under the premise that being super flexible they would best suit our needs. The latex of these membranes however was not only quickly corroded away by the hydraulic fluid, but helium diffused through the latex material from the helium compression space into the hydraulic fluid space. Both of these facts forced us to search for an alternative solution—a flexible membrane material that was both inert to hydraulic fluid and also capable of sealing helium gas. The membrane rubber material not only allows for the needed flexible movement of the membrane but is also able to seal the helium well in a hydraulic fluid environment. Silicon elastomers and other elastic materials may be used provided that they are impervious and resistant to both working gas and working liquid and can withstand the repetitive flexing.

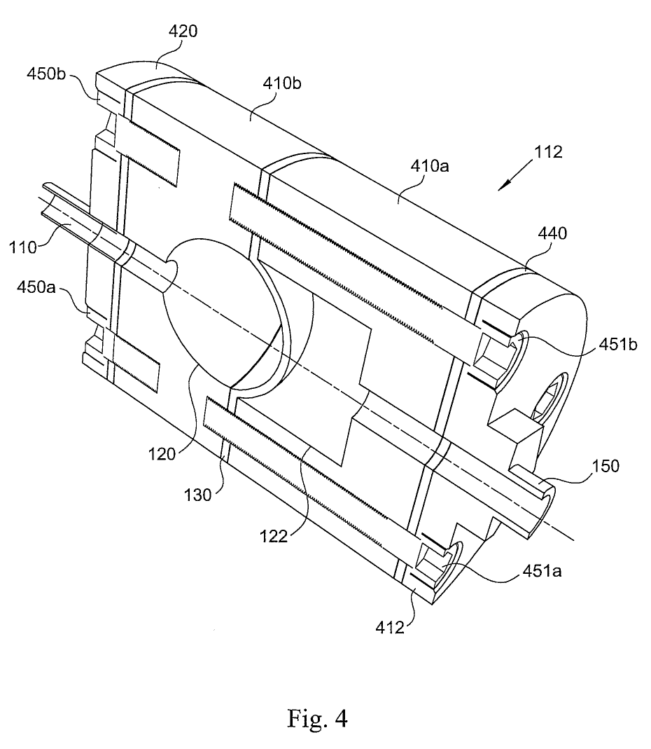

Another improvement to the initial membrane was with regards to its geometry. With the initial simple flat geometry, the rubber underwent considerable stretching every cycle in order to fit the compression space on the down stroke. This stretching of a visco-elastic material at higher frequencies not only constitutes a considerable work loss mechanism but also causes significant wear to the material. As a result we designed a pre-formed nipple-like geometry referred to as the “flip-flop” membrane. As can be seen in FIG. 4 this pre-formed membrane has a geometry which allows it to flip its direction back and forth. Only the corner edge undergoes bending stress as it flips back and forth. This corner bending stress on the perimeter however leads to considerably less losses, fatigue and wear than in the case of the whole membrane undergoing visco-elastic stretching.

FIG. 4 schematically depicts some details of a compression volume incorporating an oscillating membrane and a negative compression space according to an exemplary embodiment of the current invention.

Hydraulic pressure oscillation are transferred through transfer line 150 into hydraulic chamber 122 where it acts on flip-flop membrane 130, pushing it from the configuration of FIG. 4 to the configuration of FIG. 1. Flip-flop membrane 130 pushing against the working gas in gas compression space 120, creating high pressure oscillations in the working gas which are transferred to the pulse tube cryocooler within the cryostat 113 by helium transfer line 110. It should be noted that stroke 140 of flip-flop membrane 130 is larger than stroke 160 of master piston 180 due to the smaller diameter of flip-flop membrane 130 relative to the diameter of master piston 180.

Flip-flop membrane 130 is hermetically secured between the two parts 410a and 410b which together make the body of hydraulic chamber 122.

Screws 450a and 450b (only two are shown for simplicity) pushes the cryocooler flange 420 against gasket 430 which hermetically seals the flange to body of hydraulic chamber part 410b.

Similarly, Screws 451a and 451b (only two are shown for simplicity) pushes the transfer line flange 412 against gasket 440 which hermetically seals the flange to body of hydraulic chamber part 410a and also pushes hydraulic chamber part 410a towards hydraulic chamber part 410b creating hermetic seal with flip-flop membrane 130.

Compression Space

In order to maximize the compression abilities of the membrane it was very important to manufacture the compression volume as a negative imprint of the membrane nipple. This can be clearly seen in FIG. 4. As the heat produced during compression must be removed it would be ideal to manufacture the whole compression space from copper or other conductive material. However, to allow filming and evaluation of the membrane during oscillation this specific compression volume was manufactured from clear Perspex. Rather than a short helium transfer tube 110 it is also expected that the copper after-cooler flange of the cryocooler can be directly screwed to the Perspex compression space instead of flange 420.

It should be noted that choice of materials, components and dimensions in the experimental demonstration system was not optimized for compactness; cost; weight; efficiency; or performance. Such optimization may be done according to the actual requirements of the system without departing from the general scope of the current invention.

Experimental Results and Discussion

The piezohydraulic actuator was connected to a miniature pulse tube and operated at various fill pressures, pressure amplitudes, and frequencies. It should be noted at this point that the primary purpose of this specific experimental project was to investigate and determine the viability of the proposed piezohydraulic actuation concept and to determine if this type of actuation concept is able to effectively provide the necessary pressure amplitudes at the relevant frequencies to efficiently operate a Stirling device in split mode. As a result of this focus the specific pulse tube cryocooler elements used in these experiments have not been described herein. Further information specifically regarding this miniature pulse tube can be found in a separate publication dedicated to this topic.

During the testing phase the actuator was cycled up from a low frequency of 0.5 Hz through a high frequency of 500 Hz while the amplitude of displacement of the actuator was varied from 0 to 120 micron. The actuator displacement, pressure amplitude of the hydraulic fluid, and pressure amplitudes of the Helium at the after-cooler of the cryocooler were measured. PV power at the entrance of the after-cooler was calculated by multiplying the measured pressure amplitude, by the measured volume displacement, and the cosine of the phase angle between them.

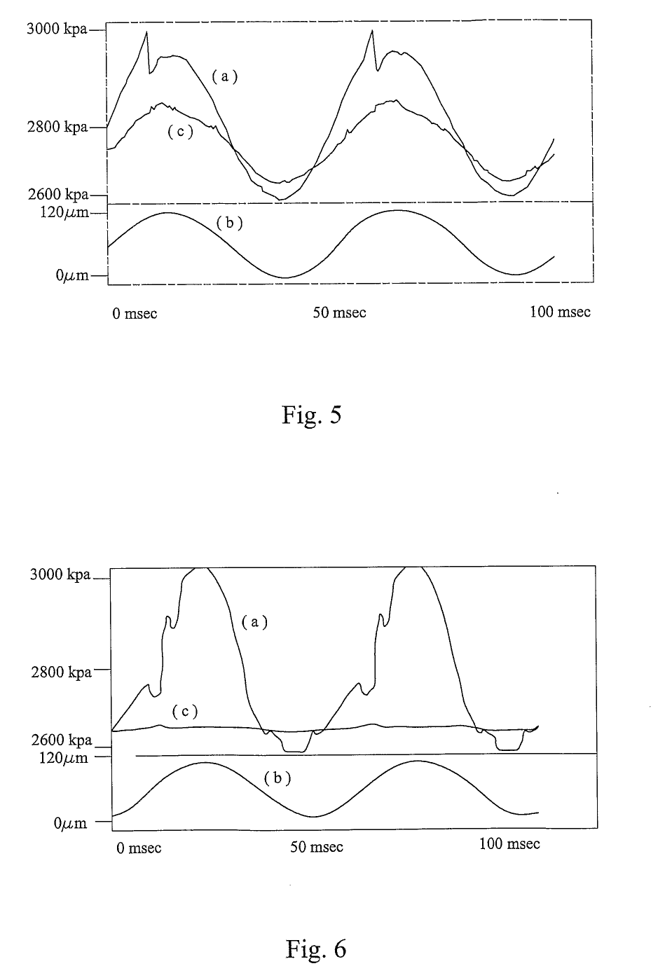

FIG. 5 depicts a graph of the operation at 20 Hz indicating:

(a) Pressure profile of the hydraulic fluid vs. time;

(b) PZT actuator displacement vs. time;

(c) Pressure profile of the Helium gas at after cooler vs. time; as measured in an experimental setup constructed according to the current invention.

At its maximum displacement of 120 microns the actuator in conjunction with the employed master piston is capable of giving a volume displacement of fluid of 0.03 cc. The miniature pulse tube to which the actuator was connected has an inner “void volume” of about 0.4 cc; this gave roughly a pressure compression ratio of a little less then 1.1. By looking at the pressure profiles in FIG. 6, which relate to an operating frequency of 20 Hz, we see some interesting results. The first phenomenon to pay attention to is the peak and then sudden pressure drop experienced by the hydraulic fluid. This is due to the non-linear response of the membrane to the flip-flop process. As it starts to flip back on itself the membrane experiences a short period of acceleration due to the nipple geometry and the elasticity of the material. This is characterized by a sudden increase in volume and thus a sudden drop in hydraulic pressure. The after-cooler, as it is buffered by the compressibility of the Helium, does not show a response to this non-linear phenomena. The other thing to notice is that the pressure amplitude of the hydraulic fluid is greater than that of the Helium. This is due to the viscosity of the hydraulic fluid and the elasticity of the membrane. We want to minimize this detrimental pressure amplitude difference. Possible solutions would be to replace the 10 W hydraulic fluid incorporated in these initial experiments with a lower viscosity fluid, and to make further efforts in minimizing the elasticity of the membrane, i.e. transparent to pressure gradients.

FIG. 6 depicts a graph of the operation at 20 Hz with insufficient compression volume in the compression space according to the current invention.

(a) Pressure profile of the hydraulic fluid vs. time;

(b) PZT actuator displacement vs. time;

(c) Pressure profile of the Helium gas at after cooler vs. time;

Another important pit-fall to be aware of is what can be seen happening in FIG. 6. If insufficient volume is left in the compression space to accommodate the volume displacement of the membrane we get substantial pressurization of the hydraulic fluid volume while barely attaining any pressurization of the Helium. Essentially we “bottom out” the membrane too soon on the down stroke. Finding the perfect initial membrane position is not trivial: on one hand we do need to achieve “complete” compression of the compression space to maximize the available PV power, but on the other hand overshooting this point is extremely detrimental. Finding the ideal equilibrium spot for the membrane takes some finesse and fine tuning but once the right position is found for a given frequency operation goes quite smoothly.

At a frequency of 130 Hz, the frequency for which the miniature cryocooler was designed to operate, the membrane produced an oscillating pressure wave which generated 600 mW of PV power. This relatively low PV power, though not ideally sufficient for this specific cryocooler design, was still enough to produce a noteworthy cooling effect at the cold heat exchanger with low temperatures dropping slightly below 250K. On a side note, this specific cryocooler should be connected to an actuator piston arrangement that would allow for additional PV power at 130 Hz. Approximately 1.5 Watts, the power for which this cooler was designed, would have produced cooling at temperatures below 150K. To enable this increased PV power input with this piezohydraulic arrangement, a larger master piston area would be necessary as well as increased fill pressures (in the neighborhood of 40 atmospheres).

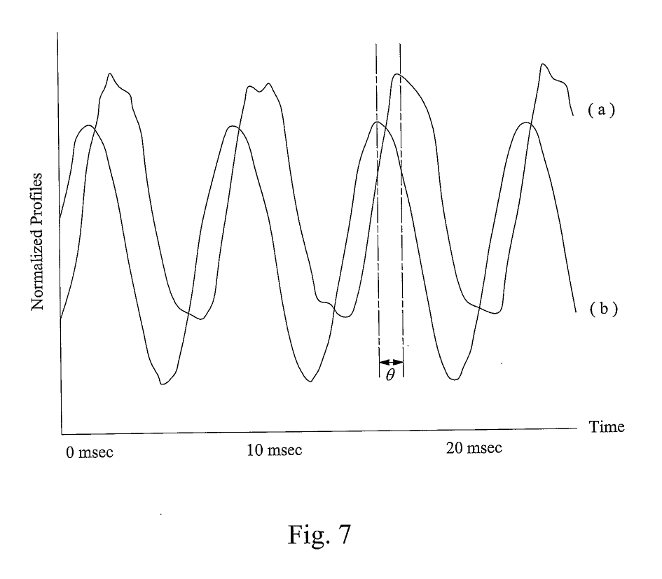

FIG. 7 depicts a graph of the phase shift between actuator displacement and pressure at membrane at 130 Hz according to the current invention.

(a) shows the hydraulic pressure at the membrane vs. time; and

(b) shows the actuator displacement vs. time.

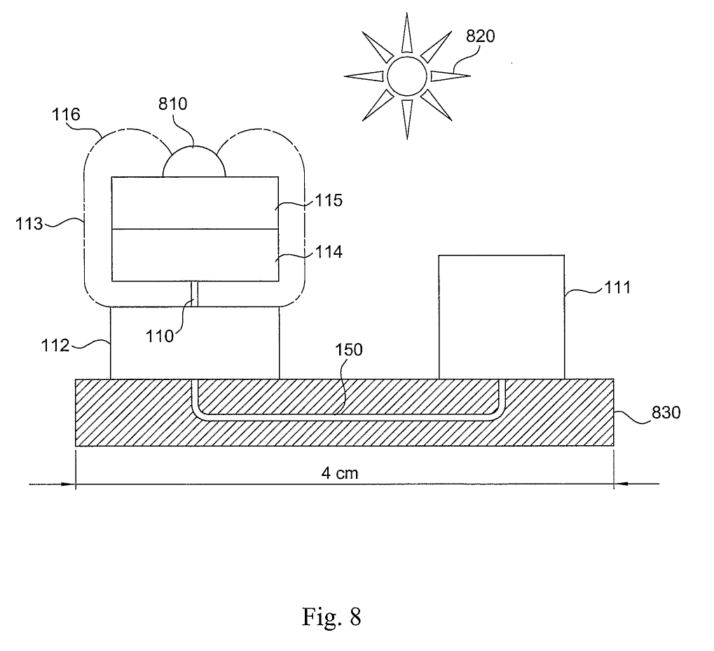

An additional issue that should be mentioned is the observed phase shifting in the hydraulic fluid, θ, between the actuator displacement on one end of the transfer line and the pressure near the membrane. FIG. 8 shows this effect clearly with an observed phase shift of approximately θ˜50° at 130 Hz. This can be largely attributed to the flexibility and compressibility of the experimental hydraulic system (Perspex casing, Teflon piping, 10 W hydraulic fluid—which is slightly compressible), but can also in part be attributed to the beginning of inertial effects in the oscillating fluid which can be quite significant, even for incompressible fluids. By referring to a previous article on the topic of oscillating flow [5] we show that in the case of Valensi Number˜10, as is the case for this experiment, we should expect a 10° degree phase shift as a result of the inertia of the incompressible oscillating flow.

### CONCLUSION

This “pieced together” table-top model of a piezohydraulic membrane oscillator was successful in producing cooling by using a miniature pulse tube in split Stirling mode and is evidence to the potential of this type of arrangement. From the results of the experimentation we may summarize some of the key advantages of such a device:
High efficiency and reliability of piezoelectric actuator relative to electromagnetic drivers at a wide frequency range.
A small high-pressure oscillator separated from the main actuator by a tube of significant length without detrimental Helium dead volumes and potentially very little phase shifting.
Use of an oscillating membrane vs. a piston solves issues of wear/sealing/dead compression space.
Membrane flip-flops with minimum stretching to assure long term operation with minimum fatigue and wear.
Potentially adaptable to considerable miniaturization.

FIG. 8 schematically depicts an IR sensor system 800 using miniature PZT driven cryocooler according to the current invention.

The miniature IR system 800 may be used in a thermal camera such as Forward-Looking Infra-Red System (FLIR), or IR communication receiver. The system according to the current invention is operating at closed loop requiring no re-supply of pressurized gas or cryogenic liquid.

Additionally or alternatively, other miniature “cold payload” such as ultra-fast or low-noise electronics my benefit from the system according to the current invention.

According to an exemplary embodiment of the invention, miniature IR system 800 comprises a main driver 111 secured to substrate 830 through which transfer tube 150 is connecting it to compression volume 112 which is connected by helium transfer line 110 to the cryocooler 114 within the cryostat 113.

IR optics, such as lens 810 focuses IR radiation from observed object 820 onto IR detector 115 cooled by cryocooler 114.

In this exemplary embodiment, length of transfer tube 150 and helium transfer tube 110 are kept to minimum to maintain the small size of the system. However, any one of the transfer tubes may be elongated to allow splitting the system to parts. Specifically, bulky main driver 111 may be remotely located if space is limited at the sensor dome or if cryostat has to be moved, for example to track a moving object or to scan the object, or to reduce vibration caused by the transducer, or to reduce electrical noise caused by the transducer. Alternatively tubes may be shortened or eliminated. Shortening the tubes reduces the bulk and the amount of fluid used.

In a cooling application, the flexible membrane is preferably butted up against the after-cooler which is the beginning of the pulse tube cryocooler.

It is the scope of disclosed embodiments hereabove to provide a miniature presser oscillator.

It is another aspect of the current invention to provide a compressor by installing input and output on-way gas valves (not shown) causing compressed gas to flow out of compression chamber 120 through the output valve when hydraulic fluid pushes the flip-flop membrane, and causing low pressure gas to flow into compression chamber 120 through the input valve when the flip-flop membrane retracts.

The valves may be installed directly at compression chamber 120. Alternatively and optionally, valves may be installed on bifurcation of pulse tube 110.

For example, compressed gas from output valve may be pre-cooled and allowed to expand and cool in a Joule Thomson orifice. Preferably the expanded gas than return to compression chamber 120 through the input valve to be re-compressed.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein is incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A presser oscillator comprising:
a transducer cyclically pushing a main piston;
hydraulic fluid transferring pressure oscillations caused by main piston to a membrane, wherein size of said membrane is smaller than size of said main; and
a compression chamber having said membrane as part of its wall filled with compressible gas, wherein said gas affected by cyclic oscillations of said membrane thus cyclically compressed.

2. The pressure oscillator of claim 1 and further comprises a cryo-cooler operated by said cyclically compressed gas.

3. The pressure oscillator of claim 1 wherein said transducer is a PZT transducer.

4. The pressure oscillator of claim 1 and further comprises a transfer tube transferring said hydraulic pressure oscillations from said main piston to said membrane.

5. The pressure oscillator of claim 1 wherein said membrane is substantially non-stretchable flip-flop membrane.

6. The pressure oscillator of claim 5 wherein moving part of said flip-flop membrane has substantially hemispherical shape.

7. The pressure oscillator of claim 1 wherein moving part of said flip-flop membrane substantially matches the volume of said compression chamber.

8. The pressure oscillator of claim 6 wherein compression chamber has substantially hemispherical shape.

9. The pressure oscillator of claim 7 wherein compression chamber and moving part of said flip-flop membrane have substantially same hemispherical shape.

10. The pressure oscillator of claim 1 wherein said main piston uses a membrane.

11. The pressure oscillator of claim 1 and further comprises:
a one way gas input valve allowing low pressure gas to enter said compression chamber; and
a one way gas output valve allowing high pressure gas to exit said compression chamber.

12. The pressure oscillator of claim 11 and further comprises a close gas system receiving high pressure gas from output valve and returning said gas at low pressure to input valve.

13. The pressure oscillator of claim 1 wherein said close gas system is a Joule Thomson cryo-cooler.
